(19) United States
(12) Patent Application Publication
(10) Pub. No.: US 2005/0247335 A1
(43) Pub. Date: Nov. 10, 2005

(54) Canopy connector

(76) Inventor: Chung-Sen Wu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/840,046

(22) Filed: May 7, 2004

(51) Int. Cl. B64D 21/00

(52) U.S. Cl. 135/121

(57) ABSTRACT

A canopy frame has a canopy connector and two connecting plates. The canopy connector has two chambers and two slant bottom blocks. Each of the chambers receives an end portion of the corresponding connecting plate. A rivet fastens the end portion of the connecting plate and the corresponding canopy connector pivotally.

### FIELD OF THE INVENTION

The present invention relates to a canopy connector, and more particularly to a canopy connector which will hold two connecting plates stably.

### BACKGROUND OF THE INVENTION

Referring to FIGS. 1 to 3, a canopy frame has a plurality of connecting plates 1 and a plurality of conventional canopy connectors 2. Each of the conventional canopy connectors 2 is disposed between two of the connecting plates 1. Each of the conventional canopy connectors 2 has two chambers 21. Each of the chambers 21 receives an end portion 11 of the corresponding connecting plate 1. A rivet 3 fastens the end portion 11 of the connecting plate 1 and the corresponding conventional canopy connector 2 pivotally. When the canopy frame is extended, the conventional canopy connector 2 and the corresponding connecting plate 1 are connected slantwise. Since a spacing 4 is formed between a bottom of the conventional canopy connector 2 and the corresponding connecting plate 1 while the canopy frame is extended, the canopy frame will not be extended stably because the conventional canopy connector 2 will not hold two corresponding connecting plates 1 stably.

### SUMMARY OF THE INVENTION

An object of the present invention is to provide a canopy connector which will hold two connecting plates stably.

Another object of the present invention is to provide a canopy connector which has a slant bottom block in order to block an end portion of a connecting plate so that the canopy connector will hold the connecting plate stably while a canopy frame is extended.

Another object of the present invention is to provide a canopy connector which has an upright block in order to block an end portion of a connecting plate so that the canopy connector will hold the connecting plate stably while a canopy frame is extended.

In accoredance with a first preferred embodiment of the present invention, a canopy frame comprises a canopy connector and two connecting plates. The canopy connector has two chambers and two slant bottom blocks. Each of the chambers receives an end portion of the corresponding connecting plate. A rivet fastens the end portion of the connecting plate and the corresponding canopy connector pivotally. When the canopy frame is extended, the canopy connector and the corresponding connecting plate are connected slantwise and one of the slant bottom blocks blocks the end portion of the corresponding connecting plate

In accoredance with a second preferred embodiment of the present invention, a canopy frame comprises a canopy connector and two connecting plates. The canopy connector has two chambers and two upright blocks. Each of the chambers receives an end portion of the corresponding connecting plate. A rivet fastens the end portion of the connecting plate and the corresponding canopy connector pivotally. When the canopy frame is extended, the canopy connector and the corresponding connecting plate are connected slantwise and one of the upright blocks blocks the end portion of the corresponding connecting plate.

### BRIEF DESCRIPTION OF THE DRAWINGS

FIG. 1 is a perspective view of a canopy frame of the prior art,

FIG. 2 is a perspective assembly view of two connecting plates and a conventional canopy connector of the prior art;

FIG. 3 is a partially sectional view of FIG. 2;

FIG. 4 is a perspective assembly view of two connecting plates and a canopy connector of a first preferred embodiment in accordance with the present invention;

FIG. 5 is a partially sectional view of FIG. 4;

FIG. 6 is a perspective assembly view of two connecting plates and a canopy connector of a second preferred embodiment in accordance with the present invention; and

FIG. 7 is a partially sectional view of FIG. 6.

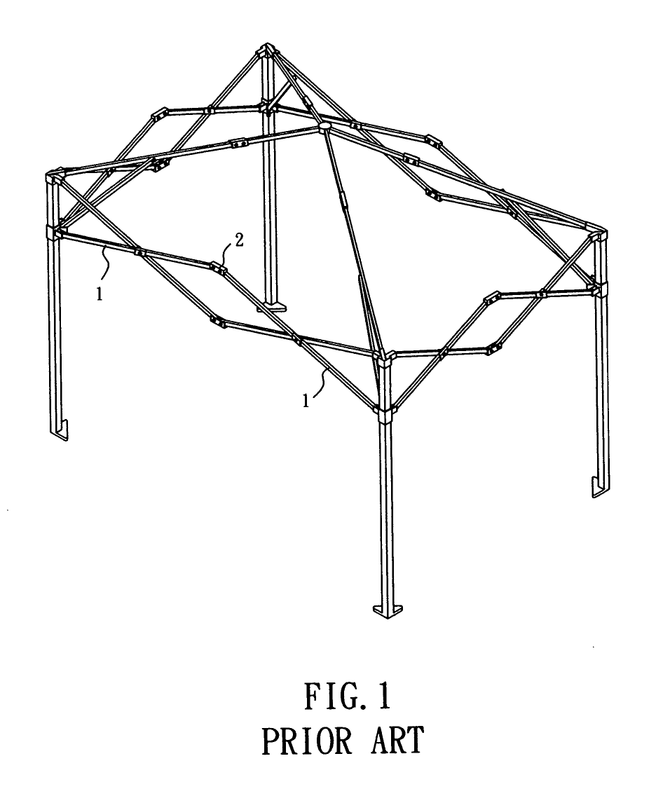

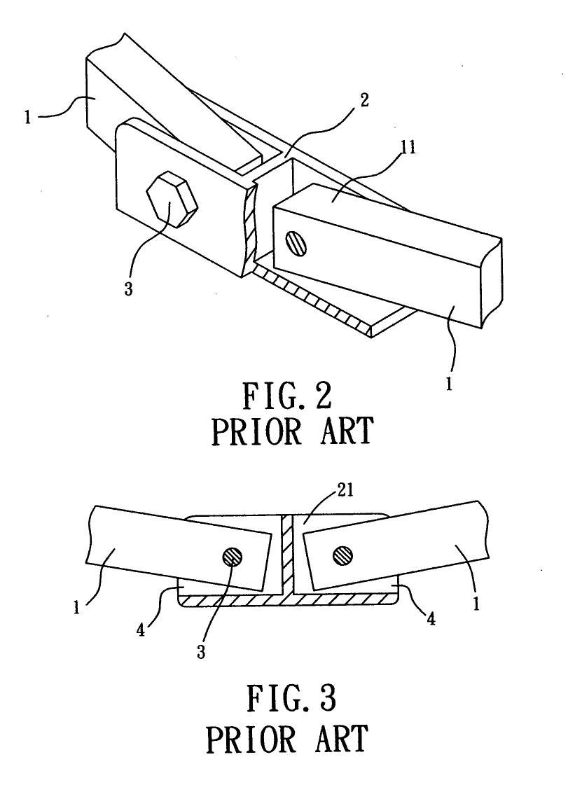

### DETAILED DESCRIPTION OF THE INVENTION

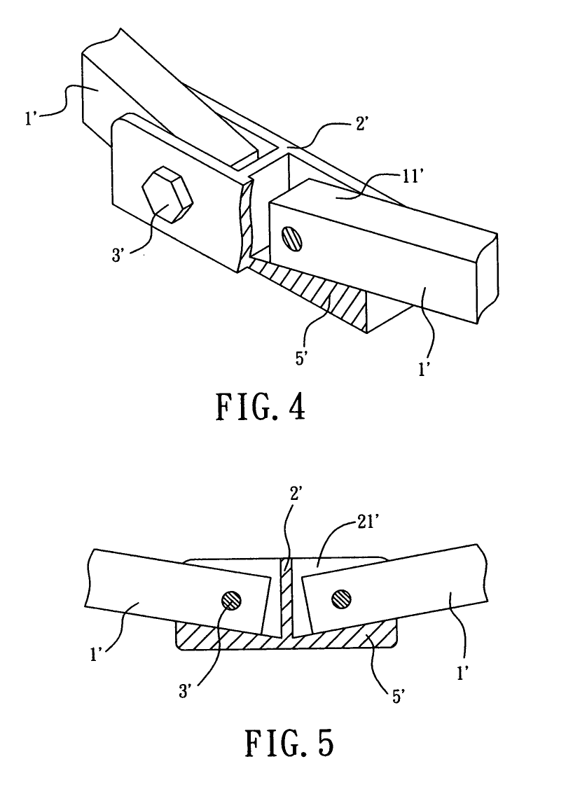

Referring to FIGS. 4 and 5, a first canopy frame comprises a canopy connector 2′ and two connecting plates 1′.

The canopy connector 2′ has two chambers 21′ and two slant bottom blocks 5′.

Each of the chambers 21′ receives an end portion 11′ of the corresponding connecting plate 1′. A rivet 3′ fastens the end portion 11′ of the connecting plate 1′ and the corresponding canopy connector 2′ pivotally.

When the first canopy frame is extended, the canopy connector 2′ and the corresponding connecting plate 1′ are connected slantwise and one of the slant bottom blocks 5′ blocks the end portion 11′ of the corresponding connecting plate 1′.

Therefore, the canopy connector 2′ will hold the corresponding connecting plate 1′ stably while the first canopy frame is extended.

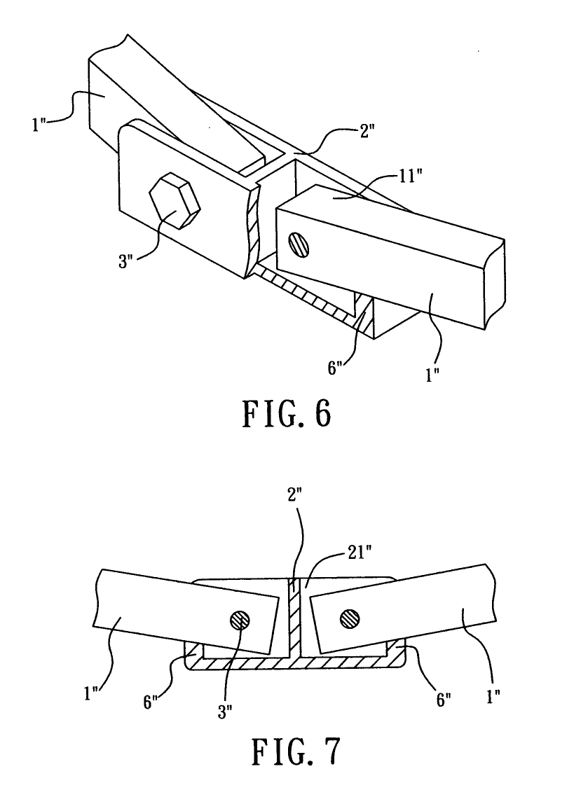

Referring to FIGS. 6 and 7, a second canopy frame comprises a canopy connector 2″ and two connecting plates 1″.

The canopy connector 2″ has two chambers 21″ and two upright blocks 5″.

Each of the chambers 21″ receives an end portion 11″ of the corresponding connecting plate 1″. A rivet 3″ fastens the end portion 11″ of the connecting plate 1″ and the corresponding canopy connector 2″ pivotally.

When the second canopy frame is extended, the canopy connector 2″ and the corresponding connecting plate 1″ are connected slantwise and one of the upright blocks 5″ blocks the end portion 1″ of the corresponding connecting plate 1″.

Therefore, the canopy connector 2″ will hold the corresponding connecting plate 1″ stably while the second canopy frame is extended.

The present invention is not limited to the above embodiment but various modification thereof may be made. Furthermore, various changes in form and detail may be made without departing from the scope of the present invention.

1. A canopy frame comprising:
a canopy connector and two connecting plates,
the canopy connector having two chambers and two slant bottom blocks,
each of the chambers receiving an end portion of the corresponding connecting plate,
a rivet fastening the end portion of the connecting plate and the corresponding canopy connector pivotally, and
when the canopy frame is extended, the canopy connector and the corresponding connecting plate are connected slantwise and one of the slant bottom blocks blocks the end portion of the corresponding connecting plate.

2. A canopy frame comprising:
a canopy connector and two connecting plates,
the canopy connector having two chambers and two upright blocks,
each of the chambers receiving an end portion of the corresponding connecting plate,
a rivet fastening the end portion of the connecting plate and the corresponding canopy connector pivotally, and
when the canopy frame is extended, the canopy connector and the corresponding connecting plate are connected slantwise and one of the upright blocks blocks the end portion of the corresponding connecting plate.
